(19) United States
(12) Patent Application Publication
(10) Pub. No.: US 2010/0032130 A1
(43) Pub. Date: Feb. 11, 2010

(54) VEHICLE WITH HEATING ELEMENT

(75) Inventor: Johan Nilsson, Hjalteby (SE)

Correspondence Address: HARNESS, DICKEY & PIERCE, P.L.C., P.O. BOX 8910, RESTON, VA, 20195, US

(73) Assignee: Vehtec AB, Goteborg (SE)

(21) Appl. No.: 12/449,849

(22) PCT Filed: Mar. 3, 2008
(86) PCT No.: PCT/SE2008/050237

§ 371 Date: Oct. 5, 2009

(30) Foreign Application Priority Data
Mar. 2, 2007 (SE) 0700533-3

(51) Int. Cl. B60H 1/00; F28F 1/00

(52) U.S. Cl. 165/41; 165/177

(57) ABSTRACT

The invention concerns a large vehicle 200 comprising a passenger compartment 210 which is equipped with at least one long heating element 300 which is arranged to operatively heat passengers and the passenger compartment 210 The heating element 300 comprises of: at least two exothermic channels 310, 320 which are designed to enclose a flow of hot fluid, and at least one exothermic intermediate section 330 which joins the aforementioned two channels, 310, 320 so that the channels 310, 320 and intermediate section 330 extend principally parallel with each other.

### TECHNICAL SCOPE OF THE INVENTION

The invention relates to a large motorised vehicle equipped with one or more heaters to heat the passenger compartment in the vehicle. Particular forms of execution of the invention relate to a large vehicle with at least one heater that is heated with hot coolant from the vehicle's engine.

### BACKGROUND OF THE INVENTION

In large motorised vehicles it is common that the coolant from the vehicle's engine is used to heat the passenger compartment. This, for example, is common in busses, train carriages or boats and the like. The engine in general is a combustion engine, for example, a diesel engine. The hot coolant is normally led via pipes to the heating element, which is located in a suitable position in the passenger compartment.

The heating element is usually located along the walls of the passenger compartment just above floor level. This placement makes it possible to heat and dry the floor area in close proximity to the heating element. This is a desired function when passengers, by means of their footwear, bring in water or snow etc into the passenger compartment. Heating and drying of the floor area is primarily achieved with the help of radiation from the heating element. Placement of the heating element along the wall just above the floor also makes it possible to heat the cold and heavier air at floor level so that the air flows up past the heating element and windows towards the roof of the passenger compartment. This is a desired function, which gives improved heating of the air volume in the passenger compartment. Heating of the air in the passenger compartment primarily takes place via convection from the heating element.

FIG. 1a is a schematic diagram of a type of heating element 100 which is frequently used to heat the passenger compartment in large vehicles, for example, in busses train carriages or boats and the like with space for numerous passengers. FIG. 1a shows the heating element 100 viewed in its longitudinal direction. The heating element 100 consists of a circular pipe 110 for the through-flow of hot water from the vehicle's engine. A number of flanges 120 are set up on the pipe 110 to increase the heat output from the heating element 100. The flanges 120 are principally made up of circular metal discs which extend perpendicularly out from the pipe 110 so that the pipe 110 is located in the centre of each flange 120. The flanges 120 do not need to be circular. The flanges can, for example, be square, rectangular or more irregular. FIG. 1b is a schematic diagram of the heating element 100 in FIG. 1a viewed from the side.

The flanges 120 and pipe 110 in the type of heating element 100 as illustrated in FIGS. 1a and 1b can, for example, be welded or soldered to the pipe 110. Alternatively the flanges 120 can be set up on the pipe 110 loosely, whereupon the pipe 110 is expanded so that the flanges 120 become fastened. Expansion can, for example, be achieved by inserting a metal rod through the pipe 110. The method is well known within the technical field and does not require a detailed description. As is probably clear from this brief description, the manufacture of a heating element consisting of one or more pipes on which flanges are set out demands complicated, expensive and time-consuming methods.

Furthermore the heating element of the type illustrated in FIGS. 1a and 1b is poorly suited for large vehicles. For example, in general the number of flanges signifies that the heat output for the heating element is too high to give an even distribution of heat throughout the passenger compartment. This has the effect of too much heat being emitted from the heating element where hot fluid flows into the element (for example, at the back of the bus close to the heating engine), while too little heat is emitted where the hot fluid has been transported over a distance in the heating element and has cooled down (for example, at the front of the bus furthest from the engine). This is not negligible in large vehicles where the passenger compartment can be 5 metres long or longer and often 10 metres long or longer and sometimes 15 metres or longer. In addition, a standard pipe has a limited total cross-sectional area that can be used to transfer heat from the pipe. The pipe also gives, for the same reason, a limited volume for the transport of hot water, which restricts the amount of energy at a specific water temperature and a specific flow that can be transported to the heating element. The restrictive cross-sectional area also gives a relatively high flow resistance. It must also be emphasised that a pipe surrounded by flanges—for example, as the pipe 110 with the flanges 120 in FIG. 1a-1b or the like—acts as a convector as the device lacks the areas intended to radiate heat into the vehicle's passenger compartment.

In light of the disadvantages shown by the known heating element for large vehicles, there is a need of a large vehicle which houses an improved heating element to heat the passenger compartment in the vehicle. This type of heating element should show a good heat output to the surroundings via radiation, for example, to heat and dry the floor in the vehicle's passenger compartment, but also via convection to heat up the air in the passenger compartment. It is also preferable that the heating element has a basic design with few component parts which means improvements regarding the manufacture and strength of the heating element. In addition, it is preferable that the heating element shows a relatively low flow resistance and an improved volume to transport the hot water.

### SUMMARY OF THE INVENTION

One purpose of the present invention is to provide a large vehicle equipped with an improved heating element to heat the passenger compartment in the vehicle. The improved heating element shows a good heat output to the surroundings via both good radiation and good convection. The improved heating element also has a basic and robust design with few component parts. Simplicity and few parts give improvements with regard to the manufacture of the heating element. Furthermore, the forms of execution of the present invention show a low flow resistance and an improved volume for the transport of hot water.

At least a part of the aforementioned purpose is achieve according to a first aspect of the invention, which provides a large vehicle housing a passenger compartment equipped with a least one long heating element designed to provide heat for the passengers in the passenger compartment. The heating element comprises a least two exothermic channels that are adapted to enclose a flow of hot fluid, for example, the hot coolant from the vehicle's engine. The heating element also comprises a least one exothermic intermediate section that links the two aforementioned channels so that the channels and the intermediate section primarily extend parallel to each other.

A second aspect of the invention is aimed towards a large vehicle embracing the characteristics in the first aspect and which is distinguished by the heating element having a width that primarily corresponds to the width of the widest of the channels.

A third aspect of the invention is aimed towards a large vehicle embracing the characteristics in the first aspect and which is distinguished by at least one of the aforementioned channels having primarily an elliptical form. An elliptical shaped channel gives the possibility of achieving a larger cross-sectional area compared with a circular channel. In particular, the width of the heating element is used more efficiently.

A fourth aspect of the invention is aimed towards a large vehicle embracing the characteristics in the first aspect and which is distinguished by the intermediate section in the aforementioned heating element comprising of a least one main hollow intermediate channel that extends along the heating element. The hollow intermediate channel in the intermediate section means that less material is required to manufacture the heating element compared to when a solid intermediate channel is used.

A fifth aspect of the invention is aimed towards a large vehicle embracing the characteristics in the first aspect and which is distinguished by the intermediate section in the aforementioned heating element consisting of a first side section which is connected to a first side of the channels and a second side section which is connected to a second primarily opposite side of the channels. The occurrence of two side sections gives an improved heat output.

A sixth aspect of the invention is aimed towards a large vehicle embracing the characteristics in the third aspect and which is distinguished by the intermediate channel in the aforementioned heating element being arranged to be operatively utilised as an air shaft for the transport of air which is heated by the channels and which is then released out into the passenger compartment.

A seventh aspect of the invention is aimed towards a large vehicle embracing the characteristics in the first aspect and which is distinguished by the aforementioned heating element being manufactured in one piece. When the heating element is manufactured in one piece it gives increased strength and a simpler manufacturing process compared to heating elements manufactured several different parts.

An eighth aspect of the invention is aimed towards a large vehicle embracing the characteristics in the seventh aspect and which is distinguished by the aforementioned heating element being extruded.

A ninth aspect of the invention is aimed towards a large vehicle embracing the characteristics in the first aspect and which is distinguished by the aforementioned heating element being manufactured of aluminium.

Additional benefits of the present invention and resulting forms of execution will be evident from the following detailed description.

It must be emphasized that the terms “comprised/comprising” in those instances these are used in this description denote the occurrence of the stated characteristics, number, step or component or the like. However this does not exclude the occurrence or addition of one or more other characteristics, numbers, step or components or the like.

### BRIEF DESCRIPTION OF THE DRAWINGS

FIG. 1a is a schematic end view of a known type of heating element 100 for heating of passenger compartments in large vehicles.

FIG. 1b is a schematic side view of heating element 100 in FIG. 1a.

FIG. 2 shows an exemplifying large vehicle in the form of a bus 200 equipped with numerous heating elements 300.

FIG. 3a shows an preferred form of execution of heating element 300.

FIG. 3b shows the preferred forms for channels 310, 320 in the heating element 300.

FIG. 3c shows a cross-section of the heating element 300 in FIG. 3a along the intersection A-A.

FIG. 4 shows the heating element 300 and a manifold 400 which in the installed state permits the inflow and/or outflow of hot fluid to and/or from the heating element 300.

FIG. 5 shows the circular channel in FIG. 3b.

FIG. 6 shows the elliptical channel in FIG. 3b.

FIG. 7 shows a schematic diagram of the heating element 300 (to the right) equipped with cooling fins 500 (to the left).

### DETAILED DESCRIPTION OF PRINCIPAL FORMS OF EXECUTION

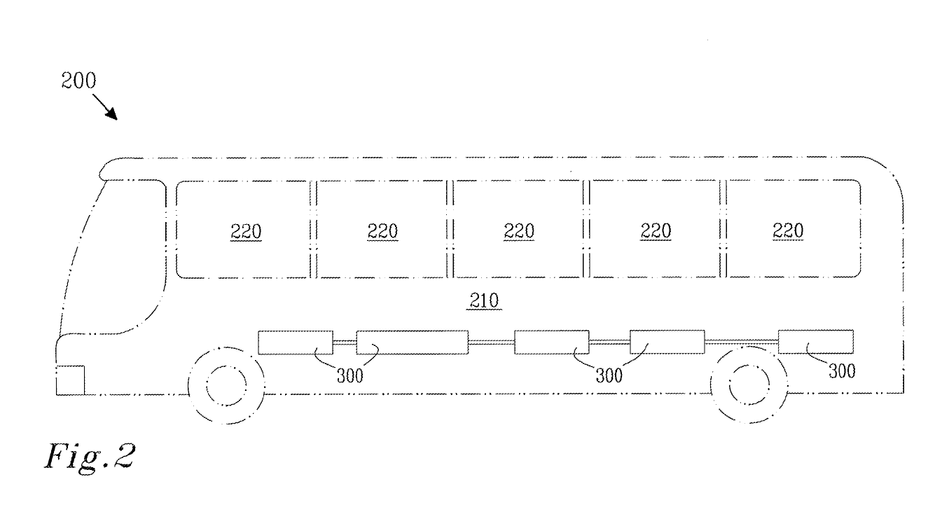

FIG. 2 shows an exemplifying large vehicle in the form of a bus 200 schematically according to a form of execution of the present invention. The bus 200 has space for numerous passengers, for example, more than four passengers or more than six passengers. As is well known buses for public transport can, for example, accommodate 50 sitting passengers or more. Some buses can even accommodate more than 100 sitting passengers, which, for example, is the case with some articulated buses. The present invention can beneficially be implemented in these types of buses and in other large vehicles with space for numerous passengers.

The bus 200 shown schematically in FIG. 2 is drawn with dashed lines to indicate that the invention concerns the interior of the bus's passenger compartment 210 and not the external body and other exterior parts of the bus 200.

As shown in FIG. 2 the passenger compartment 210 in the bus 200 is equipped with several heating elements 300. It is preferable that the heating element 300 is fed with hot coolant from the engine that propels the bus 200. Other heat sources for heating water or other suitable fluids can naturally occur, for example, electrically powered heat sources or petrol or diesel-powered heat sources and other types of heating devices.

The heating element 300 is principally positioned along an exterior wall below the window 220 in the passenger compartment 210. More precisely it is preferable for the heating element 300 to be arranged just above the floor in the passenger compartment 210. It addition, it is preferable that the heating element 300 extends principally parallel with the floor in the passenger compartment 210. In a much preferred form of execution the heating element 300 extends at the level of the feet or the small of the leg of the passengers or slightly higher. The exemplifying FIG. 2 shows several heating elements 300 connected in series after each other. The heating element 300 can, for example, be interconnected with pipes or hoses or similar channel elements.

For a person skilled in the art it is well-known that busses—in accordance with that described above—in general are equipped with heating elements that are fed with hot coolant from the bus's engine, where the elements are arranged along one of bus's external walls so that it extends primarily parallel with the floor in the passenger compartment, level with the feet of the sitting passengers. In other words, this does not need to be described further.

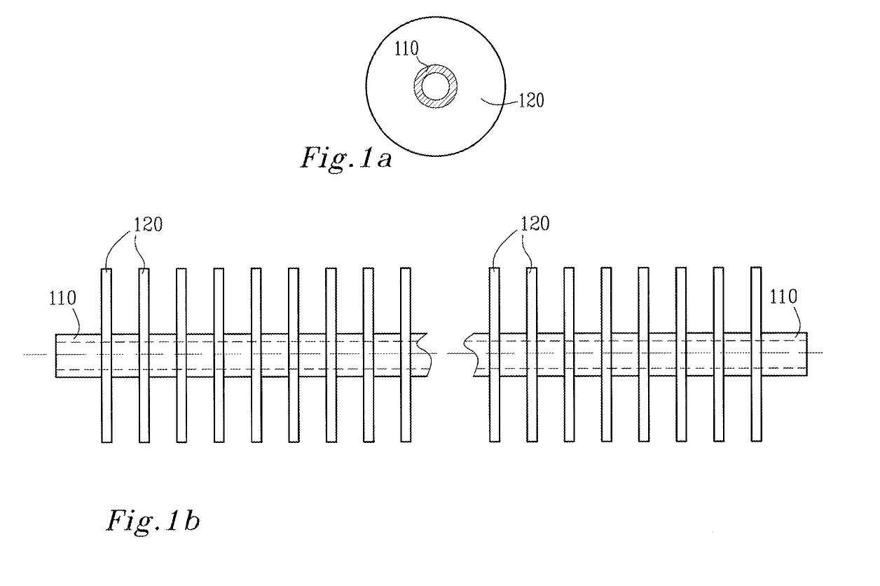

In accordance with that discussed above with reference to FIGS. 1a and 1b known busses with heating elements show several disadvantages. For example, the heating element typically contains several different components that are assembled, which gives a complicated, expensive and time consuming production. In addition, the heating element lacks surfaces designed for the radiation of heat out into the passenger compartment.

The present invention supplies a large vehicle with improved heating elements to heat the passenger compartment in the vehicle, where the heating element has a very simple and robust design with few component parts at the same time as the element shows a good heat output to the surroundings through both convection and radiation. Furthermore, the forms of execution of the heating element show a low flow resistance and an improved volume for the transport of hot fluid from the vehicle's engine or another heat source in the vehicle. Among others, this makes the heating element, according to the invention, more suitable for large vehicles than the heating element used up until now in large vehicles.

If we return to FIG. 2, it can be established that the passenger compartment 210 in the bus 200 can be 5 metres long or more and frequently 10 metres long or more and not infrequently 15 metres or more. FIG. 2 shows several heating elements 300 positioned one after another along an exterior wall in the passenger compartment 210. The length of the heating element 300 is therefore shorter than the length for the passenger compartment 210. Two or more heating elements 300 in the bus 200 can have the same length. However, there is nothing to prevent some or all heating elements 300 to be different in length. In other forms of execution the bus 200 can be equipped with heating element 300 that extends along the whole passenger compartment 210, i.e. the heating element can be 5 metres long or more, or 10 metres long or more and up to 15 metres long or more. The passenger compartment in smaller large vehicles with space for fewer passengers—for example, with space for six passengers or more—can e.g. be 3 metres long or more and the heating element 300 can then be about 3 metres long or slightly shorter.

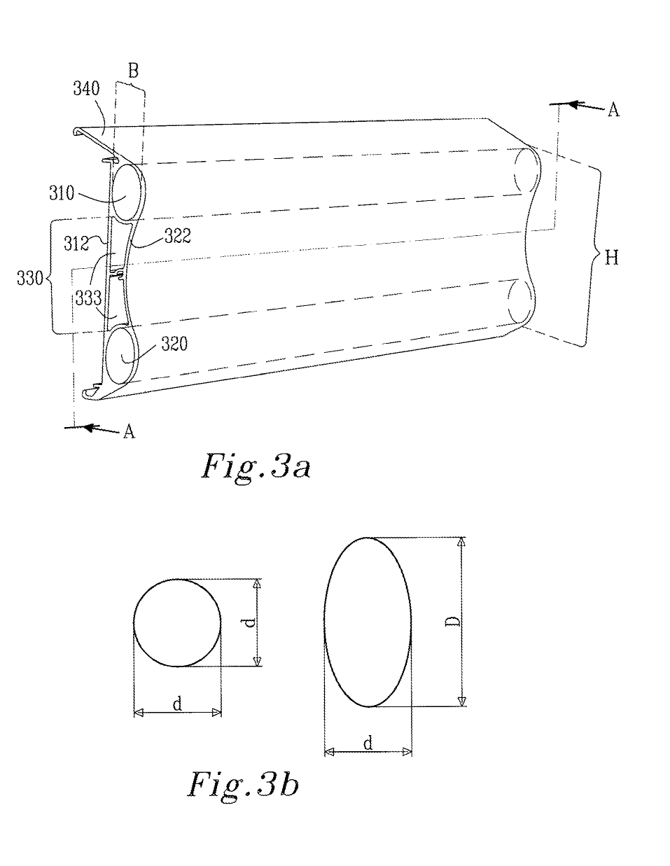

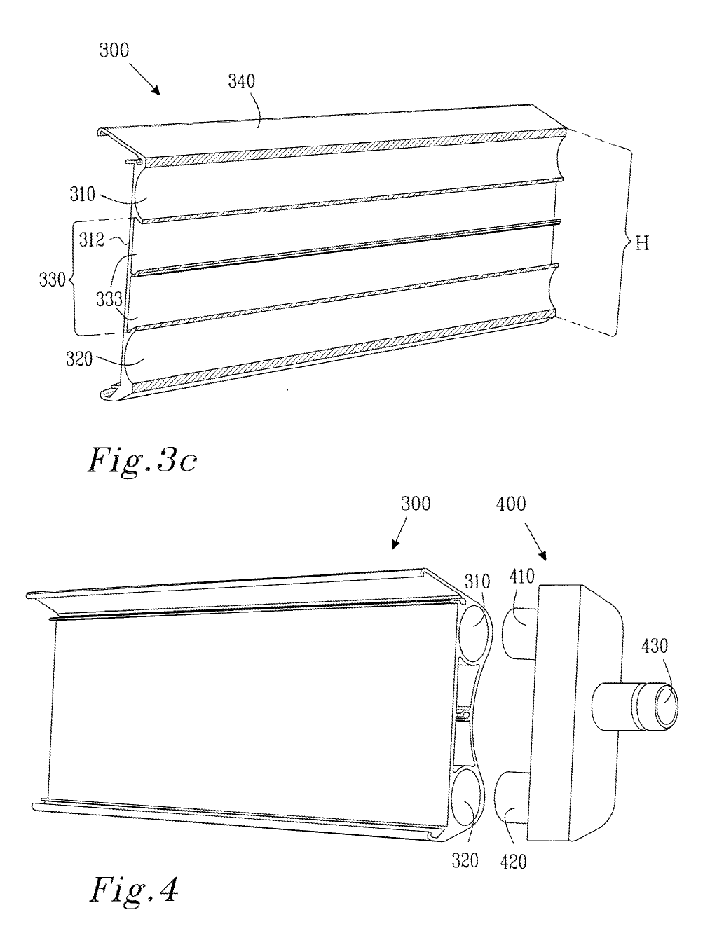

FIG. 3a shows a preferred form of execution of the heating element/elements 300 which are positioned in the passenger compartment 210 in the bus 200. The heating element 300 in FIG. 3 contains a first channel 310 and a second channel 320 which are interconnected via the intermediate section 330 so that the channels 310, 320 primarily extend substantially parallel with each other. The channels 310, 320 are adapted to enclose a flow of hot fluid, principally hot coolant from the engine in the bus 200. It is preferred that channels 310, 320 extend primarily on the same plane so that the channels 310, 320 and the intermediate section 330 form a long and mainly rectangular shaped box. Even if two channels 310, 320 are shown in FIG. 3a the present invention is not limited to two channels. On the contrary, the invention can, for example, comprise three channels and two intermediate sections, where a first and a second channel are interconnected with each other via a first intermediate section and where the second channel and a third channel are interconnected with each other via a second intermediate section. More generally the heating element 300 can comprise numerous ducts 310, 320 where each pair of two adjacent channels 310, 320 are interconnected with one intermediate section 330.

The intersection 330 contains principally a first side section 312 which is connected to a first longitudinal side of the channels 310, 320 and a second side section 322 which is connected to a second primarily opposite longitudinal side of the channels 310, 320. More precisely, the first and second side sections 312, 322 are connected to the channels 310, 320 so that the side sections 312, 322 extend between the channels 310, 320 mainly parallel with each other. Each side section 312, 322 consist principally of a disc-like part which with the channels 310, 320 form at least one hollow intermediate channel 333 which extends primarily along the whole heating element 300.

The two side sections 312, 322 give the heating element 300 an improved stability and an improved heat output compared to if a single thin disc-like section 312, 322 had be used as intermediate section 330. This follows, among others, from that each of the side sections 312, 322 show a longitudinal contact against each of the channels 310, 320. In total this gives four longitudinal contacts for the heat transfer from the channels 310, 320 to the side sections 312, 322. If a single thin disc-like side section 312, 322 had been used this would give a longitudinal contact against each of the channels 310, 320 for heat transfer from the channels 310, 320 to one of the end side sections 312, 322, i.e. all in all only two longitudinal contacts.

The hollow intermediate channel 333 in the intermediate section 330 means that less material is required to manufacture the heating element 300 compared to if a solid intermediate channel had been used. As the channels 310, 320 are interconnected using an intermediate section 333 increased stability and strength are obtained compared to if two or more separate pipes or the similar channels had been used. This is the case even if the separate pipes were held together with the help of flanges through which the pipes would have extended.

The heating element 300 is manufactured principally in a single piece through extruding a metal, for example, aluminium. Even other methods and/or other heat-conducting materials can occur.

In an form of execution of the present invention the intermediate channel 333 can be used as an air duct through which air—for example cold air from the outside of passenger compartment 210—can be transported and heated by the hot fluid in the channels 310, 320 to then flow out into the passenger compartment 210. The heated air can, for example, flow out into the passenger compartment 210 through small holes or similar lead-throughs (not shown) in one or both of the side sections 312, 322. Alternatively or as a complement the heated air can flow out through one end of the intermediate channel 333, which then must be left open. In a similar fashion the cold air can be taken into the heating element 300 via one end of the intermediate channel 333 or via holes directly in from the side of intermediate channel 333.

As already mentioned above it is preferred that the channels 310, 320 and intermediate section 330 form a long heating element 300 which mainly takes the form of a rectangular shaped box. It is also preferred that the height H is approximately in the interval 100-400 millimetres and that the width B is in the interval 15-50 millimetres. It is even more preferable that the width B is less than a seventh of the height H. However, the width B can be less than one fifth of the height H, or less than a quarter of the height H or even less than a third of the height H.

Over and above the channels 310, 320 and the intermediate section 330 can—as in evident FIG. 3a—heating element 300 be equipped with different forms of spacer devices 340 or the like which for example can create a distance between the heating element 300 and the wall in the bus's 200 passenger compartment 210. In a similar fashion, the heating element 300 can be equipped with different types of fastening devices (not shown) which for example, can be arranged to secure the heating element 300 in the passenger compartment 210.

The channels 310, 320 in the heating element 300 have principally a regular inner surface, i.e. an area with a minimum of indications of fracture, for example, in the form of sharp corners or the like which, for example, occur in rectangular channels. Regular surfaces without indications of fracture give an increase in strength which is particularly advantageous in connection with the vehicle, as the mechanical strains in moving vehicle are significantly greater than in, for example, buildings and similar stationary structures.

In a form of execution of the present invention the inside of the channels 310, 320 are principally circular, as shown to the left in FIG. 3b. The channels 310, 320 can also adopt other regular forms which consist of parts of circular or other curved surfaces that lack indications of fracture. It is evident from FIG. 3b that a circular like channel has the diameter d.

It is however preferred that the channels 310, 320 in the heating element 300 are substantially elliptical, as shown in FIG. 3a and to the right in FIG. 3b. It is evident from FIG. 3b that an elliptical channel has the width d and the height D. In the forms of execution where the channels 310, 320 are not only elliptical but primarily perfect ellipses, d corresponds to the ellipse's short axis and D the ellipse's long axis.

Unless otherwise expressively stated or which is evident from the context, the diameter of the circle d and the width of the ellipsis d denotes the “width” of the channel 310, 320. In a similar fashion, the diameter of the circle d and the height of the ellipsis D denote the “height” of the channel 310, 320.

In the forms of execution of the invention as illustrated in FIGS. 3a and 3b a circular like channel 310, 320 or an elliptical channel 310, 320 with the width d takes up the whole width B of the heating element 300. In a similar way it is preferred that a circular like channel with the height d or an elliptical like channel with the height D take up less than a third of the heating element's height H or less than a quarter of the heating element's height H.

FIG. 3c shows a cross-section of the heating element 300 in FIG. 3a along the intersection A-A. A half of the channels 310, 320 are displayed in cross section and in a similar fashion one side section 312 and one half of the intermediate channel 333 are shown.

The heating element 300, which has been described above with reference to FIG. 3a-3c has a significantly smaller width than the type of heating element 100 with pipe 110 and flanges 120 as described above with reference to FIG. 1a-1b and which traditionally has been used in busses and other large vehicles. A heating element 300 according to the present invention can therefore be installed so that it does not extend as far from the wall in the bus's 200 passenger compartment 210 as a traditional heating element 100.

Even if the heating element 300 is now used without flanges the channels 310, 320 and intermediate section 330 still give a sufficient heat radiation area to heat the passenger compartment 210 in the bus 200. This is especially clear when the intermediate section 330 consists of two spatial separated and radiating side sections 312, 322, as described above. The heating element 300 is simple and inexpensive to manufacture. Principally the heating element 300 is mainly manufactured in a single piece, for example, through extrusion. This gives a very strong and robust heating element 300 which is well-suited to the mechanical strains that occur in a moving vehicle.

Compared with the traditional heating element 100, the heating element 300 is also better suited to heat a passenger compartment in large vehicles such as buses and the like. For example, the number of flanges 120 on the traditional heating element 100 usually signifies that the heat output is too high to give an even distribution of heat throughout the passenger compartment. This has the effect where too much heat is emitted from the heating element 100 where hot fluid flows into the element 100 (for example, at the back of the bus close to the heating engine), while too little heat is emitted where the fluid has been transported over a distance in the heating element 100 and has cooled down (for example, at the front of the bus furthest from the engine).

Furthermore, compared with the traditional heating element 100, the heating element 300 is better suited to heating the passenger compartment in large vehicles such as buses and the like as the heating element 300 presents two channels 310, 320 while the traditional heating element 100 only presents one channel, i.e. the pipe 110. In addition, the surface on the outside of the side section 322 acts as an effective radiator when the surface is arranged directed straight out towards the passenger compartment 210 in the bus 200. The radiation is effective as there is only a thin wall between the channels 310, 320 with the hot water and the passenger compartment.

In the preferred form of execution as shown in FIG. 3a-3c, the channels 310, 320 in the heating element 300 are also, principally elliptical. An elliptical shaped channel gives the possibility of achieving a larger cross-sectional area compared with a circular shaped channel. In particular, the width B of the heating element 300 is used more efficiently. An elliptical channel with a specific width can extend further in towards the centre of the heating element 300 than a circular channel with the same width and in doing so creates a larger cross-sectional area without increasing the width B of the heating element 300. In this way the amount of energy, which at a specific water temperature and a specific flow can be transported out to the heating element 300, increases. This also gives a relatively low flow resistance, which means that the pump required to circulate the fluid in the elliptical channels can be less powerful compared to the pump required for circular channels.

Below it is shown in more detail that a heating element 300 where the pipes (channels 310, 320) have an elliptical form give a significantly lower pressure drop than a circular pipe (22% of the cylindrical pipe's pressure drop). Furthermore, the convective heat transfer is between 38 and 100% greater for the elliptical pipe than for the circular pipe. In addition, a swirling movement is created in the elliptical pipe on account of natural convection which further increases the heat transfer by 100% for the elliptical pipe. The swirling movement is very weak in the circular pipe.

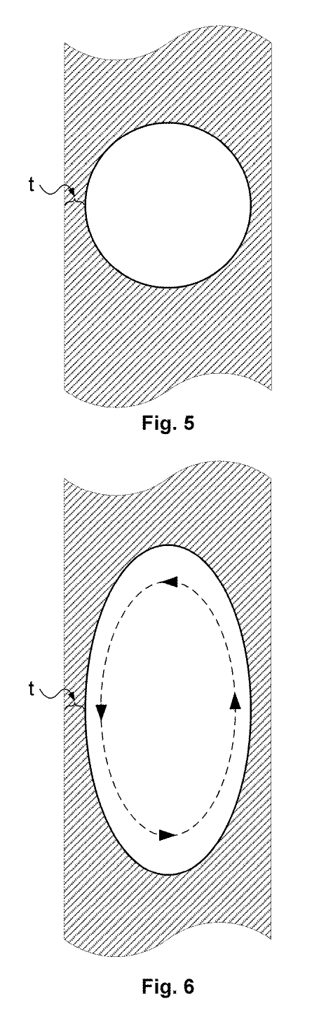

In FIG. 5 a cylindrical cross-section of the pipe in a radiator is shown and in FIG. 6 an elliptical cross-section for a pipe in a radiator is shown. The pipes with these cross sections have previously been shown in FIG. 3b. In the following a description is given of the background as to why the elliptical cross section is more effective than the circular.

### Pressure Drop

In order to maximise the heat transfer between the water in the channels 310, 320—i.e. the pipe in FIG. 5-6—to the ambient air or to a possible cooling fin, it is desirable that the thickness t for the principally vertical parts of the walls which separate the fluid (for example, water) in the pipes from the ambient air is as thin as possible and that the area for the principally vertical parts should be as large as possible. If the pipe is elliptical this means that the short axis of the ellipse is selected so that it principally is equal in size to the diameter of the pipe d, see FIG. 3b.

As is well known the cross-sectional area for an ellipse Ae and the cross-sectional area for a pipe Ar can be described through the following relationship:

$${A}_{e} = \frac{π Dd}{4} and {A}_{r} = \frac{π {d}^{2}}{4} \qquad ( 1 )$$

We then get with d and D=2d that the cross-sectional area for the elliptical pipe is twice the size of the cross-sectional area of the circular pipe, i.e. Ae=2Ar. This means that the velocity for the water in the circular pipe is twice the size of the velocity in the elliptical pipe. With d=15 millimetre and the volume flow V=7.5 litres per minute the velocity in the circular pipe will be U=0.71 m/s. The pressure drop will then be (see, equation 8.20a in F. P. Incropera and D. P. DeWitt. Fundamentals of Heat and Mass Transfer. John Wiley & Sons, New York, 4 edition, 1996):

$$Δ p = f \frac{ ρ {U}^{2}}{2 d} \\ f = 0 \text{,} 316 {Re}_{d}^{- 1 / 4} \\ \begin{matrix}{Re}_{d} = Ud / v \\ = 0 \text{,} 71 \cdot 0 \text{,} 0.15 / 1 \cdot {10}^{- 6} \\ = 10600\end{matrix} \qquad ( 2 )$$

where ρ is the water's density. The coefficient of friction will be f=0.031 and the pressure drop per metre will be Δp=520 Pa/m.

The hydraulic diameter for an ellipse can be approximated according to

$${D}_{h} = \frac{4 Ae}{Pe} \\ \begin{matrix}{P}_{e} = \frac{1}{4} {\int }_{0}^{2 π} {[ {d}^{2} + ( {D}^{2} - {d}^{2} ) {sin}^{2} ( v ) ]}^{1 / 2} d v \\ ≅ {π ( \frac{{D}^{2} + {d}^{2}}{2} )}^{1 / 2}\end{matrix} \qquad ( 3 )$$

We then get Pe=23.7 millimetres and dh=19 millimetres.

This gives

Re_{d}=Udₕ/v=0.35·0.0191·10⁻⁶=6700 (4)

The pressure drop for the ellipse will be (with U=0.35 m/s) Δp=115 Pa/m. Accordingly the pressure drop for the elliptical pipe is only 22% (115/520=0.22) of the pressure drop for the cylindrical pipe.

### Heat Transfer

Let us now estimate the so-called Nusselt number (i.e. dimensionless heat transfer per area unit). This can be done in different ways.

As a first estimation the Nusselt number can be calculated according to (see, equation 8.59 in F. P. Incropera and D. P. DeWitt. Fundamentals of Heat and Mass Transfer. John Wiley & Sons, New York, 4 edition, 1996):

$${Nu}_{d} = \frac{hd}{k} = 0 , 023 {Re}_{d}^{4 / 5} {Pr}^{1 / 3} \qquad ( 5 )$$

where k is the water's thermal conduction coefficient, h is the thermal exchange constant and Pr is the Prandtl number. As the relationship between the Reynhold's number (Re_{d}) for the elliptical and cylindrical pipe is 6700/10600=0.63 the Nusselt number will be 31% (0.63^{4/5}=0.69) lower for the elliptical pipe compared with the cylindrical.

The Nusselt number for the elliptical pipe will be:

$$\begin{matrix}{Nu}_{d , ellips} = 0 \text{,} 023 \cdot {( \frac{0 \text{,} 35 \cdot 0 \text{,} 019}{{10}^{- 6}} )}^{4 / 5} \cdot 5 \text{,} {8}^{1 / 3} \\ = 47 \text{,} 6\end{matrix} \qquad ( 6 )$$

A second estimation concerns the laminar flow. For laminar flow it has been shown through experiments that for an elliptical pipe with D/d=2 the Nusselt number increases compared with a circular pipe (see page 7-138 in W. H. Rosenow and J. P. Harnett. Handbook of heat transfer, 1973). This indicates that it is not obvious that the Nusselt number drops for an elliptical pipe compared with a cylindrical pipe.

In the third estimation we approximate the flow in the left-hand half of the cylindrical pipe and the elliptical pipe with a boundary layer. In a boundary layer the Nusselt number is calculated according to (see equation 7.36-37 in F. P. Incropera and D. P. DeWitt. Fundamentals of Heat and Mass Transfer. John Wiley & Sons, New York, 4 edition, 1996):

Nuₓ=0.0296Reₓ^{4/5}Pr^{1/3}

δ=0.37xRₓ^{-1/5} [symbol] Re_{δ}=0.37Reₓ^{4/5}

where δ is the thickness of the boundary layer. We then get

$$\begin{matrix}{Nu}_{δ} = \frac{h δ}{k} \\ = 0 , 08 {Re}_{δ} {Pr}^{1 / 3}\end{matrix} \qquad ( 8 )$$

For the cylindrical and elliptical pipe we set δ=d/2, i.e. the Nusselt number is equally in both cases.

### Heat Transfer Per Length Unit

In the section above we estimated how much the Nusselt number changes when you switch from a pipe with a circular cross-section to a pipe with an elliptical cross-section. One of the advantages of the elliptical cross section is that it has a greater area for the principally vertical thinner (thickness t) parts of the walls which separate the water in the pipe from the ambient air, see FIG. 6. These walls corresponds to the part of the side sections 312, 322 which form the channels 310, 320 in the heating element 300. The third estimation above takes the fact into consideration that the elliptical cross section has a greater area for the primarily vertical walls. The heat-transmitting area between water and air is proportional to D for the elliptical pipe, see FIG. 3b and FIG. 6. On the other hand, for the circular pipe, the heat transmitting area between water and air is proportional to d, see Fig. FIG. 3b and FIG. 5. The convective heat transfer per length unit between water and the pipe surface will then be (equation 8 is used at the first equals sign):

$$\begin{matrix}{Q}_{circ} = h ( {T}_{m} - {T}_{w} ) d / 2 \\ = \frac{{N}_{u δ k}}{2 δ} ( {T}_{m} - {T}_{w} ) d \\ = \frac{{Nu}_{circ} k}{2 k} ( {T}_{m} - {T}_{w} )\end{matrix} \\ \begin{matrix}{Q}_{ellips} = h ( {T}_{m} - {T}_{w} ) D \\ = \frac{{N}_{u δ k}}{2 δ} ( {T}_{m} - {T}_{w} ) D \\ = \frac{{Nu}_{ellips} k}{k} ( {T}_{m} - {T}_{w} )\end{matrix} \qquad ( 9 )$$

where T_{w} is the pipe wall's temperature and Tₘ is the water's bulk temperature. The calculations in the section above showed that 0.69≦Nuₑₗₗᵢₚₛ/Nu_{circ}≦1, which means that the convective heat transfer per length unit for the elliptical pipe is between (2·0.69−1)·100=38% and 100% greater than for the circular pipe.

### Heat Transfer Due to Natural Convection

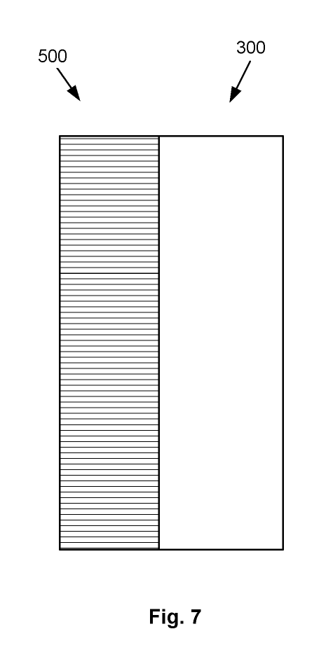

We now assume that in FIG. 6 the hot water flows through the pipe in the paper's plane. We also assume that the right-hand wall is hotter than the left-hand. This, for example, can occur when cooling fins 500 are arranged on the outside of the side section 312 but not on the outside of side section 322, i.e. the cooling fins are arranged on the left-hand wall but not on the right-hand wall as shown schematically in FIG. 7. This can also occur when the left-hand wall is turned towards the outer walled in the passenger compartment 210 in the bus 200 where the heating element 300 is arranged. During winter conditions the outer wall of the vehicle can be significantly colder than the air inside the vehicle, for example, due to low heat insulation. In this context it is preferred that the right-hand wall (i.e. the outside of side section 322) is turned substantially directly towards the passenger compartment 210 in the bus 200 so that the section 322 can act as an effective radiator without plates or other material that prevents heat radiation. In the same way it is preferred that the left-hand wall (i.e. the outside of section 312) is turned substantially directly towards the outer wall in passenger compartment 210 in the bus 200 without plates or other heat obstructing material in between. As it is shown schematically in FIG. 7 there can however be cooling fins 500 arranged on section 312. The cooling fins boost the heating element's 300 function as a convector through the hot upward moving airflow, which passes the element 300 being heated more efficiently, at the same time as the element 300 acts as a radiator through the surface (the outside of section 322) which is turn directly towards the passenger compartment 210.

The temperature difference between the two vertical longer walls of the elliptical pipe in FIG. 6 mean that the density of the water along the right-hand hotter wall is lower than by the colder left-hand wall. On account of the natural convection this causes the water to flow upwards along the right-hand hotter wall and downwards along the colder left-hand wall. The direction of flow has been schematically indicated in FIG. 6 with a dashed line equipped with arrows. This results in a swirling movement where the water flows in the paper's plane at the same time as it flows anti-clockwise. This swirling movement is much stronger in an elliptical pipe than in a circular pipe as the length for the vertical parts of the walls for the elliptical pipe (length D=2d) is twice the size of the circular pipe (length d).

Heat transfer due to natural convection can be calculated according to (see, equation 9.50 in F. P. Incropera and D. P. DeWitt. Fundamentals of Heat and Mass Transfer. John Wiley & Sons, New York, 4 edition, 1996):

$${Nu}_{a} = 0 \text{,} 22 {( \frac{{P}_{r}}{0 , 2 + {P}_{r}} {Ra}_{a} )}^{0 , 28} {( \frac{D}{d} )}^{- 1 / 4} \\ {Ra}_{a} = \frac{g β ( {T}_{warm} - {T}_{cold} ) {D}^{3}}{{v}^{2}} {P}_{r} \\ β = {( 0 \text{,} 5 ( {T}_{warm} + {T}_{cold} ) )}^{- 1} \qquad ( 10 )$$

where g is the gravitational acceleration (g=9.81) and the temperatures T_{cold} (cold wall) and T_{warm} (hot wall) must be in degrees Kelvin. If we assume that T_{cold}=273+20° K and Thot=273+30° K we get Nuₐ=37. Accordingly, we find that the heat transfer on account of the swirling movement is nearly as large as that of convective heat transfer. (Nu_{d,ellips}), see equation (6) above.

To summarise the above, we have shown that the heating element 300 where the two pipes (channels 310, 320) have an elliptical form both give a significantly lower pressure drop and greater convective heat transfer than a circular pipe. In addition, if the heating element 300 is arranged so that one of the two thinner vertical walls, which separate the water in the pipe from the ambient air becomes significantly colder than the other wall a swirling movement is created in the elliptical pipe on account of natural convection which further increases the heat transfer.

Known buses and other known large vehicles are not equipped with such an efficient, and solid heating element 300 as described above, which in addition, can easily and inexpensively be manufactured in one piece through e.g. extrusion. Note that the heating element 300 does not consist of several separate pipes or discs or the like that demand special separate fastening devices or that are held together with the help of flanges.

It is preferred that the whole or principally the whole heating element 300 is manufactured of a material with good heat conducting properties. The material can, for example, be a heat conducting metal, such as copper or stainless steel. It is especially preferred that the heating element 300 is manufactured of a heat conducting lightweight material, for example, aluminium.

FIG. 4 shows a manifold 400 which is designed to be fitted against the end of the heating element 300. The manifold 400 is principally manufactured in an appropriate metal material or plastic material and comprises a first assembly unit 410 and a second assembly unit 420 in the form of recipient channels. The first recipient channel 410 is adapted to make a sealed joint with the heating element 300 against the first channel 310, while the second recipient 420 is adapted to make a sealed joint with the heating element 300 against the second channel 320 so that fluid can flow freely without leakage between heating element 300 and the manifold 400.

A fastening is principally made through the recipient channels 410, 420 being inserted into the channels 310, 320 in the heating element 300. This does not exclude that other fastening methods can come into question, e.g. a method where the recipient channels 410, 420 are screwed on or in the channels 310, 320 with the help of threads. Fastening and sealing can also take place with the help of seals, e.g. with the help of O-rings which are arranged on the recipient channels 410, 420. In addition fastening and sealing can be implemented through gluing, fusing, vulcanisation or other adhesion, sealing and/or interconnecting method. There is nothing to prevent several methods being utilised simultaneously, e.g. insertion or screwing together with seals and/or gluing. It should also be added that the recipient channels 410, 420 do not need to extend from the manifold 400, as illustrated in FIG. 4. Other forms of execution of the heating element 300 can have channels 310, 320 that extend into the recipient channels 410, 420.

The recipient channels 410, 420 or similar assembly units on the manifold 400 in FIG. 4 emerge together in a branch channel 430. The fluid that communicates through each channel 310, 320 in the heating element 300 can in this way flow together in the branch channel 430. Consequently, the branch channel 430 makes up the inlet and outlet for the heating element 300. Through attaching a manifold 400 at each end of the heating element 300 as described above it is possible to connect several heating elements 300 together with the help of basic pipe coupling parts, for example, hose coupling parts manufactured of an appropriate material. The coupling parts can, for example, be attached to the branch channel 430 with the help of one of the methods described above.

It must be emphasised that the description above with associated figures is only intended to illustrate the present invention. It is obvious to an expert within the field that the invention can vary and be changed in many different ways without deviating from the scope and spirit of the requested protection in the enclosed patent claims.

1. A large vehicle comprising a passenger compartment which is equipped with at least one long heating element which is arranged to operatively heat passengers and the passenger compartment, where the heating element comprises:
at least two exothermic channels which are designed to enclose a flow of hot fluid,
at least one exothermic intermediate section which joins the aforementioned two channels so the channels and intermediate section extend principally parallel with each other.

2. The large vehicle in claim 1,
wherein:
the heating element has a width which principally corresponds to the widest of the channels.

3. The large vehicle in claim 1,
wherein:
at least one of the aforementioned channels (310, 320) has a substantially elliptical form.

4. The large vehicle in claim 1,
wherein:
intermediate section in the aforementioned heating element comprises of at least one hollow intermediate channel which extends along the heating element.

5. The large vehicle in claim 1,
wherein:
the intermediate section in the aforementioned heating element comprising a first side section which is connected to a first side of the channels and a second side section which is connected to a second primarily opposite side of the channels.

6. The large vehicle in claim 3,
wherein:
the intermediate channel in the aforementioned heating element being arranged to be operatively utilised as an air duct to transport air which is heated by channels and which then flows out into the passenger compartment.

7. The large vehicle in claim 1,
wherein:
the aforementioned heating element being manufactured in one piece.

8. The large vehicle in claim 7,
wherein:
the aforementioned heating element being extruded.

9. The large vehicle in claim 1,
wherein:
the aforementioned heating element being manufactured of aluminum.
